(19) United States
(12) Patent Application Publication
(10) Pub. No.: US 2006/0155672 A1
(43) Pub. Date: Jul. 13, 2006

(54) Systems and methods for single input installation of an application

(75) Inventors: Prescott V. Lee, Menlo Park, CA (US); Kyle S. Mashima, Menlo Park, CA (US)

Correspondence Address: CARR & FERRELL LLP, 2200 GENG ROAD, PALO ALTO, CA, 94303, US

(73) Assignee: FilmLoop, Inc.

(21) Appl. No.: 11/173,691

(22) Filed: Jul. 1, 2005

Related U.S. Application Data
(60) Provisional application No. 60/644,254, filed on Jan. 13, 2005.
(60) Provisional application No. 60/644,129, filed on Jan. 13, 2005.

(51) Int. Cl. G06F 17/30

(52) U.S. Cl. 707/1

(57) ABSTRACT

A system and method for single input installation of an application is provided. The method comprises receiving a single input for an application from a user. In response to the single input, the application is downloaded, data associated with the application is stored on a computing device associated with the user, the data is configured on the computing device, and the application is executed on the computing device.

### CROSS-REFERENCE TO RELATED APPLICATIONS

The present application claims the benefit and priority of U.S. provisional patent application Ser. No. 60/644,254 filed on Jan. 13, 2005 and entitled “Systems and Methods for One Click Photo Sharing,” and U.S. provisional patent application Ser. No. 60/644,129, filed on Jan. 13, 2005 and entitled “Systems and Methods for Drag and Drop Loops,” which are herein incorporated by reference.

This application is related to co-pending U.S. application Ser. No. ______, entitled “Systems and Methods for Providing Loops,” filed on Jul. 1, 2005, co-pending U.S. application Ser. No. ______, entitled “Systems and Methods for Single Act Media Sharing,” filed on Jul. 1, 2005, co-pending U.S. application Ser. No. ______, entitled “Systems and Methods for Providing an Interface for Interacting with a Loop,” filed on Jul. 1, 2005, co-pending U.S. application Ser. No. ______, entitled “Systems and Methods for Sharing Loops,” filed on Jul. 1, 2005, and co-pending U.S. application Ser. No. ______, entitled “Loop Channels,” filed on Jul. 1, 2005, which are herein incorporated by reference.

### BACKGROUND OF THE INVENTION

1. Field of the Invention

The present invention relates generally to software applications, and more particularly to systems and methods for single input installation of an application.

2. Description of Related Art

Conventionally, a user who wants a new software product can buy the software product as a packaged software product and load a software application onto a computing device associated with the user. If the user wants to instead purchase the software application online, or otherwise access the software application online, the user can locate a website from which to access and download the software application.

The computing device associated with the user typically guides the user through a series of steps in order to configure the software application onto the computing device. The user may specify setting's related to the software application and the computing device during this series of steps.

Often, users desire quick access to the features provided by the software application. Sometimes the user is confused by the series of steps required to install the software application, or may become annoyed by being required to click through the various steps.

For example, the user may desire an image on the Internet. The user, however, does not know what program is necessary to load and display the image. As a result, the user may have to decipher the image's file name extension or perform other research to discover an appropriate program to load and display the image. The user may then have to determine if the appropriate program is available and where to download it. Further, the user may have to discover how to download, load, and display the image within the appropriate program. As a result, the less experienced user may ultimately choose not to download, access, display, or play media files.

Therefore, there is a need for a system and method for single input installation of an application.

### SUMMARY OF THE INVENTION

The present invention provides a system and method for single input installation of an application. A single input for an application is received from a user. In response to the single input, the application is downloaded, data associated with the application is stored on a computing device associated with the user, the data is configured on the computing device, and the application is executed on the computing device.

### BRIEF DESCRIPTION OF THE DRAWINGS

FIG. 1 illustrates an exemplary environment for providing single input installation of an application;

FIG. 2 illustrates an exemplary environment for providing a loop;

FIG. 3 illustrates a screen shot of an exemplary loop;

FIG. 4 illustrates a flowchart of an exemplary process for single input installation of an application;

FIG. 5 illustrates a flowchart of an exemplary process for providing a loop;

FIG. 6 illustrates an exemplary graphical user interface for installing a loop in response to a single user input;

FIG. 7 illustrates a schematic diagram for an exemplary media engine;

FIG. 8 illustrates exemplary components associated with the server; and

FIG. 9 illustrates an exemplary graphical user interface.

### DESCRIPTION OF EXEMPLARY EMBODIMENTS

Single input installation of an application allows users to install and configure applications with a single request. In one embodiment, the user clicks on an icon to request the installation of an application. The application downloads to the user's computer which subsequently stores the application. The user's computer is then automatically configured to execute the application and the application is executed.

In another embodiment, once the user provides the single input thereby requesting the installation of the application, an installer is downloaded to the user's computer. The installer downloads and stores the application within the user's computer. The installer then configures the computer to execute the application and the application is then executed.

In a further embodiment, the user may perform the single action indicating the user's desire to download a data file. A data file is any single file that may be opened by an application (e.g. a music file, an image file, a text file, etc.) As a result, the user's computer is scanned to determine if the user's computer possesses the appropriate application to open the chosen data file. If the appropriate application is not installed on the user's computer, the application is automatically downloaded and stored on the user's computer. The user's computer is configured and the application is executed. Subsequently, the data file may be automatically downloaded and loaded into the program.

By installing applications in response to the single input by the user, the installation process of applications may be simplified.

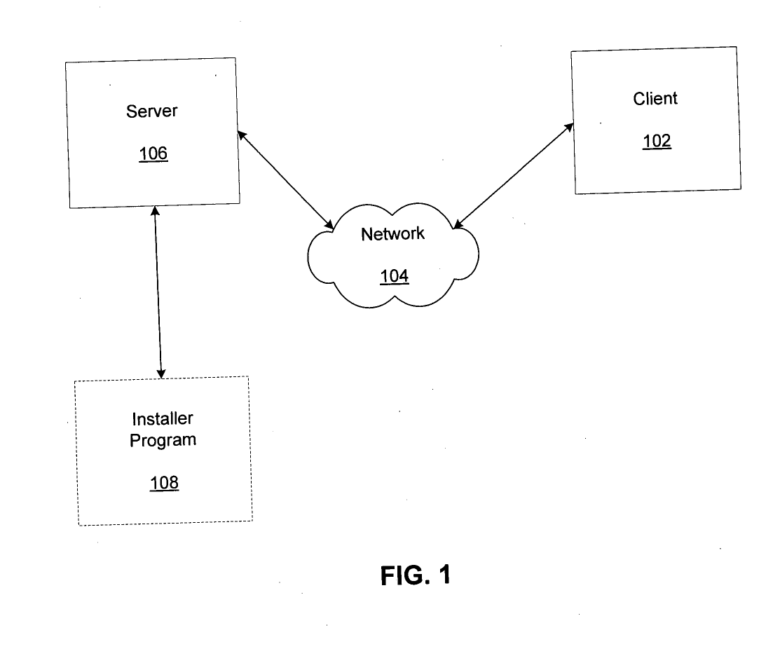

Referring now to FIG. 1, an exemplary environment for providing single input installation of an application is shown. A client 102 may communicate over a network 104 with a server 106. The client 102 may include any type of computing device, such as a cellular telephone, a laptop computer, a personal digital assistant (PDA), and so on.

The server 106 receives inputs from the client 102 via the network 104. Any type of input, such as requests for applications, data, and so forth may be received and processed by the server 106. In accordance with one embodiment, the server 106 downloads an application to the client 102 in response to a single input, such as a single click from a user associated with the client 102. Any type of input may be received in accordance with various embodiments, such as checking a box, clicking a button, consenting to terms of an agreement, selecting an input from a drop down menu, inputting a password, and so on.

Optionally, the server 106 may access an installer program 108, which may reside at the server 106 or otherwise be accessed by the server 106. The server 106 may provide the installer program 108 to the client 102 to automatically install the application at the client 102 in response to a request from a user associated with the client 102. For example, in response to a single input from the user, the server 106 may provide the installer program 108 along with the application to the client 102, where the installer program 108 installs the application with no further input required from the user. Any type of installer program 108 may be provided according to various embodiments. Further, any type of application may be provided to the client 102 by the server 106 in accordance with various embodiments.

In exemplary embodiments, the user accesses a web page over the network 104. After or as the user accesses the web page, an installer program may automatically download and execute on the client 102 associated with the user. For example, the installer program may be embedded in the web page as an applet. In response to the single input from the user, such as clicking on an installation button on the web page, the server 106 may then download the application to the client 102 along with an installer program. The installer program at the client 102 is automatically invoked and stores data associated with the application, configures an operating system associated with the client to execute the application, and executes the application. Accordingly, in response to the single input from the user requesting the application, the application is downloaded and executed at the client 102.

In exemplary embodiments, the application comprises a media engine for playing one or more loops for displaying media in association with a computing device of a user. The user may select various media to display in the loop. In one embodiment, the loop comprises a Filmloop™. The media engine may scroll the one or more loops including the media across a display associated with the computing device, or across any other display associated with any type of device. According to various embodiments, the media selected by the user for the loop may be shared with one or more other users at one or more other computing devices when the user drags the media to the loop, if the one or more other users share the same loop on their respective computing devices. Various other features associated with the loop are described herein.

The process of dragging and dropping media 212 within the loop 210 is described in further detail in co-pending U.S. application Ser. No. ______, entitled “Systems and Methods for Single Act Media Sharing,” filed on Jul. 1, 2005.

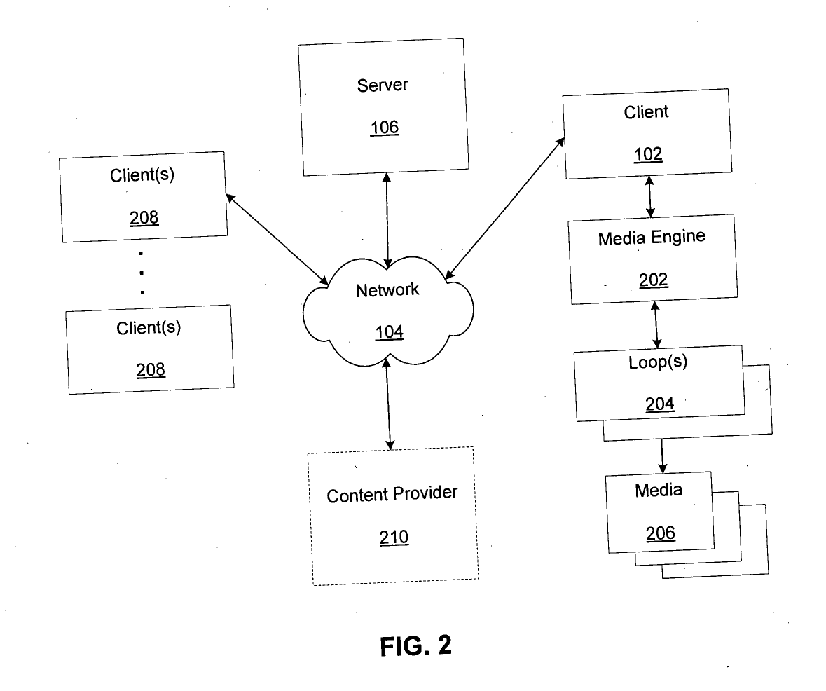

Referring now to FIG. 2, an exemplary environment for providing a loop is shown. A user is associated with the client 102, as discussed herein. The client 102 includes any type of computing device, such as a cellular telephone, a laptop computer, a personal digital assistant (PDA), and so on. The client 102 has a media engine 202 coupled to the client 102 for creating and/or generating at least one loop 204. The media engine 202 may also play the loop 204. A loop player comprises the graphical representation of the media engine 202.

The loop 204 may be comprised of various media 206. The media 206 can include photos, video, audio, images, text, advertisements, and/or any other type of media. The media 206 may appear as one or more items separated by lines, frames, or any other display item for defining the one or more items of the media 206 as separate from each other on the loop. Each item of the media 206 may itself include moving displays, motion pictures, and so forth.

In one embodiment, the loop 204 scrolls, or is otherwise played, across a display associated with the client 102. In some embodiments, the loop 204 may be manipulated by a user of the client 102 to stop, speed up, or slow down the scrolling of the loop 204, and/or any other type of manipulation. The client 102 may have more than one loop 204 that scrolls across the display at one time. Further, the client 102 may have various loop(s) 204 that play at one time and/or are stored at the client 102 to be played at a time chosen by the user associated with the client 102. The user may also play more than one loop 204, such as playing the loops 206 sequentially, in a single media engine 202.

The media engine 202 may reside on the client 102 or may be otherwise coupled to the client 102. Alternatively, the media engine 202 may be accessible to the client 102 via a network, such as the network 104 shown in FIG. 1 and FIG. 2. For example, one or more clients 102 may access the media engine 202 via the network 104 in order to create the loop(s) 204, update the loop(s) 204 with additional media 206, remove certain of the media 206 from the loop(s) 204, alter metadata associated with the loop(s) 204, modify the media 206 or metadata associated with the media 206 contained in the loop(s) 204, play the loop(s) 204, and/or perform any other functions utilizing the media engine 202.

In exemplary embodiments, the identifier assigned to the media 206 may be unique within the loop(s) 204. Further, the loop(s) 204 identifier and/or the media 206 identifier is unique within the network 104, according to exemplary embodiments. Any type of identifiers may be assigned to the loop(s) 204 and/or the media 206 according to various embodiments.

The media engine 202 may be utilized, as discussed herein, to create the loop(s) 204 using the media 206. Typically, the user at the client 102 selects the media 206 from files located on the client 102 and/or from media 206 available via the network 104. For example, the user may search for and provide photos found on the Internet to the media engine 202. The media engine 202 receives the media 206 and creates the loop(s) 204 with the media 206. The user can provide more than one item of the media 206 to the media engine 202 for creating or modifying the loop(s) 204.

The user can provide the media 206 by dragging and dropping the media 206 into the media engine 202, by initiating a command that the media 206 be used to create a new loop(s) 204 and/or modify an existing loop 204, and/or any other method of identifying the media 206 as part of the loop(s) 204. In exemplary embodiments, the user can drag a folder including more than one item of the media 206 into the loop(s) 204.

The media engine 202 may assign an identifier to each of the loop(s) 204. The media engine 202 may further assign an identifier to each of the media 206 in the loop 204. For example, the media engine 202 may assign an identifier to a loop 204 that is newly created and may also assign identifiers to each of the media 206 used to create the new loop 204. In one embodiment, the media 206 may receive the same or a similar identifier as the loop 204 to which the media 206 belongs.

The loop(s) 204 may be stored by category, dates associated with the media 206 included in the loop(s) 204, metadata associated with the loop(s) 204, or any other criteria. The criteria may be provided to the user as a default and/or the user can specify criteria for storing and/or playing the loop(s) 204. For example, in one embodiment, the user may specify that the loop(s) 204 should be played one at a time, one per day, according to a particular subject matter (e.g. such as family photo loop(s) 204, followed by fan club loop(s) 204, followed by work oriented loop(s) 204), and so forth. Any method for playing the loop(s) 204 is within the scope of various embodiments.

When the user drags and drops one or more items of the media 206 into a particular loop 204, the user is requesting that the media engine 202 modify the particular loop(s) 204 by adding the one or more items of the media 206. Accordingly, the media engine 202 assigns an identifier that is unique within the loop 204 to each of the items of the media 206 dropped by the user.

As discussed herein, the media 206 may be added to more than one loop(s) 204. Accordingly, the media 206 may have more than one identifier associated with the media 206 in order to identify the one or more loop(s) 204 which contain the media 206.

In order to add the media 206 to a loop 204 without using the drag and drop method, the user can identify the media 206 to be added and subsequently include the media 206 into the loop(s) 204 of the media engine 202. For example, the user may copy the media 206 from outside of the loop(s) 204. Subsequently, the user may paste the media 206 into the loop(s) 204. The user can identify the loop 204 according to the loop's 204 identifier, by subject matter, and/or by any other criteria that indicates to the media engine 202 which loop 204 should receive the media 206 being provided by the user.

The user can remove media 206 from a loop 204 by dragging the media 206 out of the loop 204, or identifying to the media engine 202 the media 206 to remove. Any manner of identifying the media 206 the user desires to remove from a loop 204 is within the scope of various embodiments. For instance, the user can highlight the item of the media 206 within the loop 204 and select a remove option from a drop down menu.

The media engine 202 updates the loop 204 to reflect the removal of the media 206. The media engine 202 may remove the identifiers associated with the removed media 206, or the media engine 202 can alter the metadata associated with the removed media 206. Conversely, as discussed herein, the user can add the media 206 back into a loop 204 by dragging and dropping the media 206 into the loop 204 to which the user wishes to add the media 206 or by identifying the media 206 to the media engine 202 that the user wishes to add to the loop 204.

In one embodiment, the identifiers for the loop(s) 204 and/or the media 206 may be assigned by a server 106, such as an “application server.” The server 106 may be accessed directly by the client 102 or via the network 104. The server 106 can communicate the identifiers for the loop(s) 204 and/or the media 206 to the media engine 202, so the media engine 202 can store and locate the identifiers. When the user removes, adds, or modifies an item of the media 206 from the loop 204, the server 106 can store and/or track the removals, additions, and/or modifications as updates to the loop 204. The user can also update the loop 204 by making changes to items of the media 206 in the loop 204. For example, if the user resizes an image of the media 206, the media engine 202 and/or the server 106 can include the resized image as an update to the media 206 in the loop 204. In one embodiment, the server 106 may assign the identifier to the resized image in the media 206 and include the resized image as an update to the media 206 in the loop(s) 204. Any type of modifications to the media 206 and/or the loop 204 is within the scope of various embodiments.

In one embodiment, the user of the client 102 shares one or more of the loops 204 with one or more users of one or more other clients 208. The other clients 208 may also include one or more media engines for playing the loop(s) 204, creating the loop(s) 204, modifying the loop(s) 204, and so on. The server 106 assigns the same identifier to the loop(s) 204 shared by the client 102 and the client(s) 208. The process of sharing media is described in further detail in co-pending U.S. application Ser. No. ______, entitled “Systems and Methods for Sharing Loops,” filed on Jul. 1, 2005, which is incorporated by reference. The process of sharing loops is described in further detail in co-pending U.S. application Ser. No. ______, entitled “Loop Channels,” filed on Jul. 1, 2005, which is incorporated by reference.

When a user from the client 102 makes updates to the loop(s) 204 having an identifier shared by the loop(s) 204 at the client(s) 208, the client(s) 208 receive the same updates to the loop(s) 204. As discussed herein, the updates may include any modifications to the loop(s) 204 and/or the media 206 comprising the loop(s) 204.

The server 106 can provide the updates to the loop(s) 204 on the client(s) 208 automatically, at any time after the user at the client 102 makes updates to the loop(s) 204. In one embodiment, the server 106 makes requests to the media engine 202 at various times for changes made to the loop(s) 204 at the client 102. In one embodiment, the server 106 waits for notifications from the client(s) 208 of changes made to the loop(s) 204, then provides the updates to the client(s) 208 that have loops 206 with the same identifiers. Similarly, changes made by the client(s) 208 may be automatically provided to the client 102.

In one embodiment, the media engine 202 or any other component associated with the client 102 assigns a temporary identifier to the media 206 dragged into the loop 204. The client 102 then forwards the media 206 with the temporary identifier to the server 106. The server assigns a permanent identifier to the media 206 and forwards the media 206 with the permanent identifier back to the client 102 and/or to the other client(s) 208 as an update. The temporary identifier associated with the media 206 and/or the permanent identifier associated with the media 206 may further be associated with the identifier assigned to the loop(s) 204. Any type of method for assigning identifiers to the media 206 and/or the loop 204 may be employed by any device according to various embodiments.

The one or more users at the client(s) 208 may also make updates to the loop(s) 204 that have the same identifiers as the loop(s) 204 at the client 102. In one embodiment, the user that originates a shared loop 204 can create permissions for the loop 204. For instance, the originating user may require a password before other users can submit updates to the shared loop(s) 204.

Since the server 106 may automatically distribute the updates to the client(s) 202 and 208 with loop(s) 204 that have shared identifiers, only a single act is required by the user to share the updates to the loop(s) 204 with the users at the client(s) 202 and 208.

In one embodiment, users may subscribe to loop(s) 204. For example, the user at the client 102 may post movie oriented loop(s) 204 to the Internet and other users may subscribe to those movie oriented loop(s) 204 via a registration process. For the users that subscribe to the movie oriented loop(s) 204, updates are received when the originating user makes modifications to the movie oriented loop(s) 204. As discussed herein, a user, vendor, retailer, advertiser, etc. may make loop(s) 204 available for subscription.

Once the loop(s) 204 have been set up by various users and assigned unique identifiers, the server 106 and/or the media engine 202 keeps track of the loop(s) 204 and any changes thereto. Accordingly, since the server 106 automatically distributes, or otherwise distributes, the updates to the client(s) 208 with the loop(s) 204 with shared identifiers based on the user at the client 102 modifying the loop(s) 204 by adding, removing, or changing one or more items of the media 206 within the loop(s) 204, only a single act is required by the user to share the updates to the loop(s) 204 with the users at the client(s) 208.

In one embodiment, master copies of the loop(s) 204 may be stored on the server 106. Accordingly, the user at the client 102 can modify the loop(s) 204 by accessing the server 106. The user may access the server 106 via the network 104 or in any other manner. Alternatively, the server 106 may include an index for locating the various loop(s). In another embodiment, the loop(s) 204 may be stored at the server 106, while the client 102 and/or the client(s) 208 utilize an index to retrieve particular loop(s) 204 when desired. Any storage medium may be utilized for storing the loop(s) 204, copies of the loop(s) 204, metadata, and/or indexes according to various embodiments.

In another embodiment, the server 106 may store the master copies of all the loop(s) 204 for all users along with the identifiers for the loop(s) 204 and the media 206. Accordingly, the server 106 can search for loop(s) 204 based on the identifiers, receive updates to the loop(s) 204 when users associated with the loop(s) 204 makes changes to the loop(s) 204, and automatically distribute updates for the loop(s) 204 to all user associated with the loop(s) 204. In still another embodiment, the loop(s) 204 may be stored on the server 106 in order to minimize storage on the client 102 and/or the client(s) 208, as discussed herein.

In still another embodiment, the server 106 may store versions of the loop(s) 204. Accordingly, the server 106 may maintain various copies of the same loop(s) 204, as different versions. According to another embodiment, the client 102 and/or 208 may store different versions of loop(s) 204 generated by the client 102 or of shared loop(s) 204. The server 106 and/or the client 102 may maintain an index for organizing and tracking the various versions of the loop(s) 204 according to some embodiments.

In one embodiment, a content provider 210 is coupled to the server 106 in order to provide content for the loop(s) 204. The content provider 210 may be directly coupled to the server 106 or the content provider 210 may be coupled to the server 106 via the network 104. In one embodiment, the content provider 210 is coupled to the client 102 and/or the client(s) 208 in order to directly provide the content to the loop(s) stored on the client 102 and/or the client(s) 208.

In exemplary embodiments, the content provider 210 provides advertising content to the loop(s) 204. Alternately, the content provider 210 may provide any type of content. In one embodiment, each of the loops 206 must include at least one item of the content from the content provider 210. More than one content provider 210 may be provided according to various embodiments. Accordingly, the loop(s) 204 may display advertisements or other content along with the other media 206 displayed by the loop(s) 204.

In one embodiment, the content provider 210 can specify how often the content appears within the loop(s) 204. For example, the content provider 210 may specify that the content should appear no less than between every 20^{th} item of media 206 within the loop(s) 204. If the content provider 210 modifies the content, the server 106 or the content provider 210, itself, can distribute the modified content as updates to the loop(s) 204. Accordingly, the modified content replaces the existing content in the loop(s) 204.

In one embodiment, digital content may be emailed to a central authority associated with the loop(s) 204. The central authority may then authenticate the user and distribute the digital content to appropriate loop(s) 204 and/or create new loop(s) 204 based on the digital content. The authentication may be based on username, password, and/or any other information related to the user submitting the digital content.

Although the media engine 202 at the client 102 is described as creating the loop(s) 204 from the media 206, one or more media engines at the client(s) 208 can also provide the media 206 and create the loop(s) 204, modify the loop(s) 204, and so on. In other words the client 102 and the client(s) 208 are capable of performing similar or identical functions with respect to the loop(s) 204.

The process of providing loops is described in further detail in co-pending U.S. application Ser. No. ______, entitled “Systems and Methods for Providing Loops,” filed on Jul. 1, 2005, which is incorporated by reference.

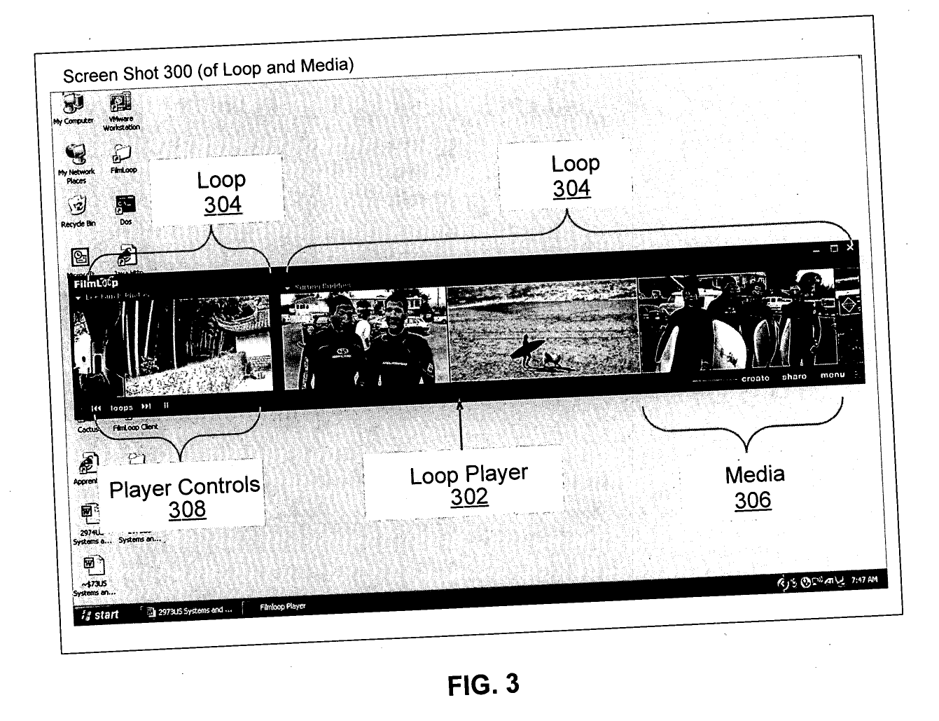

Referring now to FIG. 3, a screen shot of an exemplary loop 304, such as the loop(s) 204 discussed in FIG. 2, in accordance with one embodiment is shown. A loop player 302, such as a graphical representation of the media engine 202 discussed in FIG. 2, includes several loops 304. Each loop 304 includes several items of media 306, such as the one or more items of the media 206 discussed in FIG. 2. The loop player module 302 plays the loop 304 by scrolling the various media 306 across a display device. The display device in FIG. 3 is a desktop display.

In FIG. 3, the loop player 302 is displaying two loops 304, one entitled “Lee Family Photos” and the other entitled “Surfing Buddies.” As shown, one item of the media 306 in the “Surfing Buddies” loop 304 is a picture of four surfers. As discussed herein, various types of media 306 may be included in the loop(s) 304, such as the photograph of the four surfers, advertising content from a content provider, such as the content provider 210 discussed in FIG. 2, and so on. Although FIG. 3 shows two loops 304 adjacent to one another being played by the same loop player 302, a single loop 304 may scroll across a display device associated with a user according to various embodiments. In one embodiment, the user may scroll more than one loop 304 across the display device at different locations on the display device, rather than adjacent loops 304 played in one loop player 302, as discussed herein. Further, more than one loop 304, including adjacent loops 304 played by one loop player 302, may scroll across the display device of the user.

The loop player 302 may scroll the media 306 for the loop 304 across the display device at any speed and/or in any direction. The speed and/or direction may be a default speed, a default direction, and/or a direction and/or speed specified by the user. In one embodiment, the content provider 210 specifies the speed in order to ensure that the content provided appears at specified increments of time. In a further embodiment, the server 106 may also specify the speed and/or the direction.

The user may utilize player controls 308 to adjust the speed, the media 306 to display, and so on. For instance, the user can skip to a previous or next item of the media 306 by utilizing the player controls 308. The user can also pause the scrolling loop(s) 304. Furthermore, the user can stop the loop 304, reduce or expand the size of the loop 304, or minimize the loop 304. In one embodiment, the user may access a master set of controls that control more than one loop 304. In another embodiment, when the user adjusts the player controls 308 associated with the loops 304, other users' loop(s) 304 with the same unique identifier are automatically adjusted as well.

In order to drag the loop 304 and/or the loop player 302 to other areas of the display device, the user can grab the loop player 302 and move it to the desired area using a mouse, a keyboard, or any other coupled control device. The user can incorporate the loop 304 into a second loop, such as the loop(s) 204 discussed herein, by dragging and dropping the loop 304 into the second loop(s).

The user can drag the media 306 from the loop 304 to a second loop to modify the second loop with the media 306 that was dragged into the second loop. In one embodiment, the user may select from a drop down menu to copy and/or move the media 306 to another loop.

In one embodiment, the user may select a single item of the media 306, such as the photo of the four surfers, in order to “open” the single item of the media 306 or load a new loop associated with the single item. Opening the single item of the media 306 may enlarge the content that comprises the single item, display an alternate version of the media 306 that comprises the single item, make the content available for editing, stop the single item content from moving (in the event of moving displays), direct the user to a URL address, and so on.

Opening the single item of the media 206 may also present a new loop, or “sub loop”, associated with the single item of the media 306. For instance, if a user associated with the loop 304 selects the item with the photo of the four surfers in the media 306 in the “Surfing Buddies” loop 304, a new loop with more surfing buddies photos and/or content may be revealed. Opening a single item of the media 306 in a loop 304 having an advertisement may reveal a new loop with content provided solely by a content provider, such as the content provider 210 discussed in FIG. 2. Any type of new loop may be provided as a consequence of opening the single item of the media 306.

In one embodiment, when the user selects a single item of the media 306, the loop player 302 makes a request to a client (e.g., such as the client 102 and/or the client(s) 208), to launch a particular application running on the client 102 and/or the client(s) 208. For example, when a particular item of the media 306 in the loop 304 is selected, the loop player 302 instructs a web browser installed on the client 102 to display a particular web page. The web page may be associated with subject matter for the single item of the media 306.

In one embodiment, opening a single item of the media 306 may provide an additional option of sending the single item of the media 306 to one or more other users. For example, although two users may not share the loop(s) 304 with the same unique identifier, the two users may maintain the loop(s) 304 with similar subject matter. Accordingly, the users may send one or more of the single items of the media 306 to one another in order to update content, inform one another of advertising, etc.

One or more of the items of the media 306 can be shared between any users for any reason. In one embodiment, the content provider 210 (FIG. 2) pushes time sensitive information to users of the loop(s) 204 as one or more items of the media 306. Any type of information may be provided to users of the loop(s) 304, such as news, financial data, sales information, new product offerings, single items of the media 306 from other loop(s) 304 users, and so on. In one embodiment, the users of the loop(s) 304 can block single items of the media 306 from being presented.

The process of providing an interface for interacting with a loop is described in further detail in co-pending U.S. application Ser. No. ______, entitled “Systems and Methods for Providing an Interface for Interacting with a Loop,” filed on Jul. 1, 2005, which is incorporated by reference.

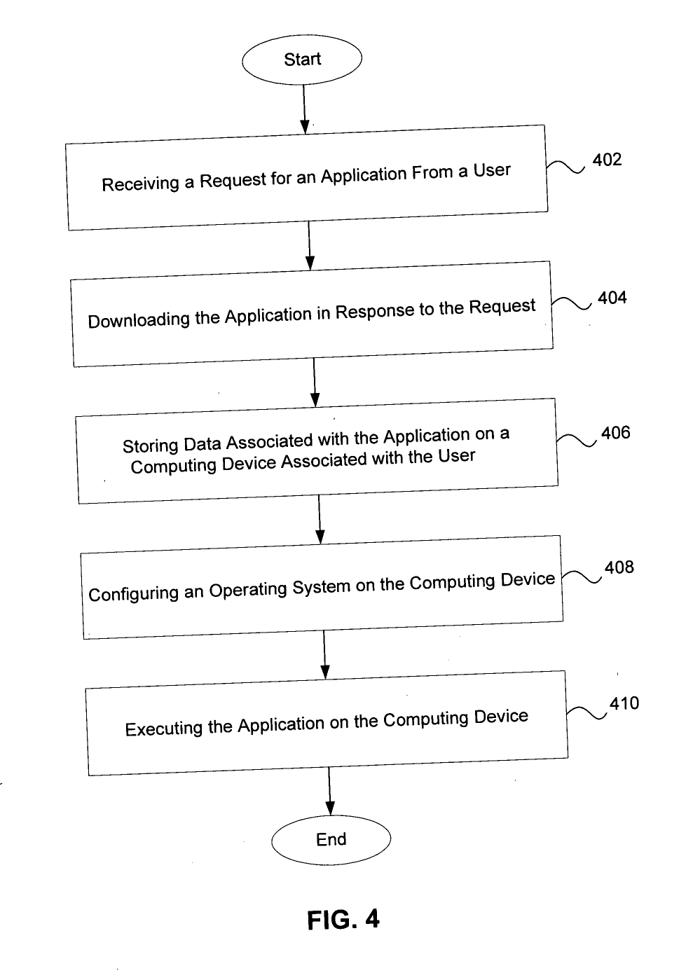

Turning to FIG. 4, a flowchart of an exemplary process for single input installation of an application is shown. At step 402, a request for an application is received from a user. As discussed herein, the application may comprise the media engine 202 playing the loop(s) 204 or any other application. The server 106 may receive the request from the user at the client 102, or at any other device. The request may comprise selecting an icon, such as a loop(s) 204 icon, agreeing to terms associated with the application, selecting the application from a drop down menu, and so forth.

At step 404, the application is downloaded in response to the request. The application may be downloaded to the client 102 associated with the user making the request. The server 106 may automatically download the application in response to the request from the user for the application.

In one embodiment, the user checks a box agreeing to the terms of an end user license agreement (“EULA”) associated with the application, which is interpreted by the server 106 as a request for the application. Accordingly, the server 106 may download the application to the client 102 associated with the user in response to receiving an indication that the user consents to the EULA. Any type of agreement may be provided according to various embodiments. Further, any type of indication of assent to terms of the agreement may be provided according to various embodiments.

At step 406, data associated with the application is stored on a computing device associated with the user. The computing device may comprise the client 102, the client(s) 208, or any other device. The data may comprise any data required by the client 102 or an operating system installed on the client 102 to install and/or execute the application. For example, the data may comprise data for presenting an icon as a shortcut to the application on a desktop display associated with the client 102. In another example, the data may be stored within specific files required by the operating system (e.g. the windows subdirectory of a client 102 operating a Microsoft Windows operating system) or the data may be stored within a specific registry.

At step 408, the operating system associated with the computing device is configured for the application. For example, data associated with the application within a registry file is configured according to configuration parameters established by the server 106, the media engine 202, the client 102, the operating system, or the user. Any type of configuration of the data may be provided according to various embodiments. In some embodiments, the server 106 stores the data and configures the data on the client 102 after the application is downloaded to the client 102.

At step 410, the application is executed on the computing device. For example, the media engine 202, as discussed herein, may automatically load the loop(s) 106 on the client 102. Any type of application, such as a word processing application, a banking application, a computer aided drawing program, and so forth may be executed on the client 102. The server 106 may install and/or execute the application on the client 102 automatically in response to the single request from the user at the client 102. Accordingly, as a result of the single request received from the user, the server 106 downloads the application, stores the data, configures the data, and executes the application on the client 102. The application may also be displayed on the client 102 by the server 106.

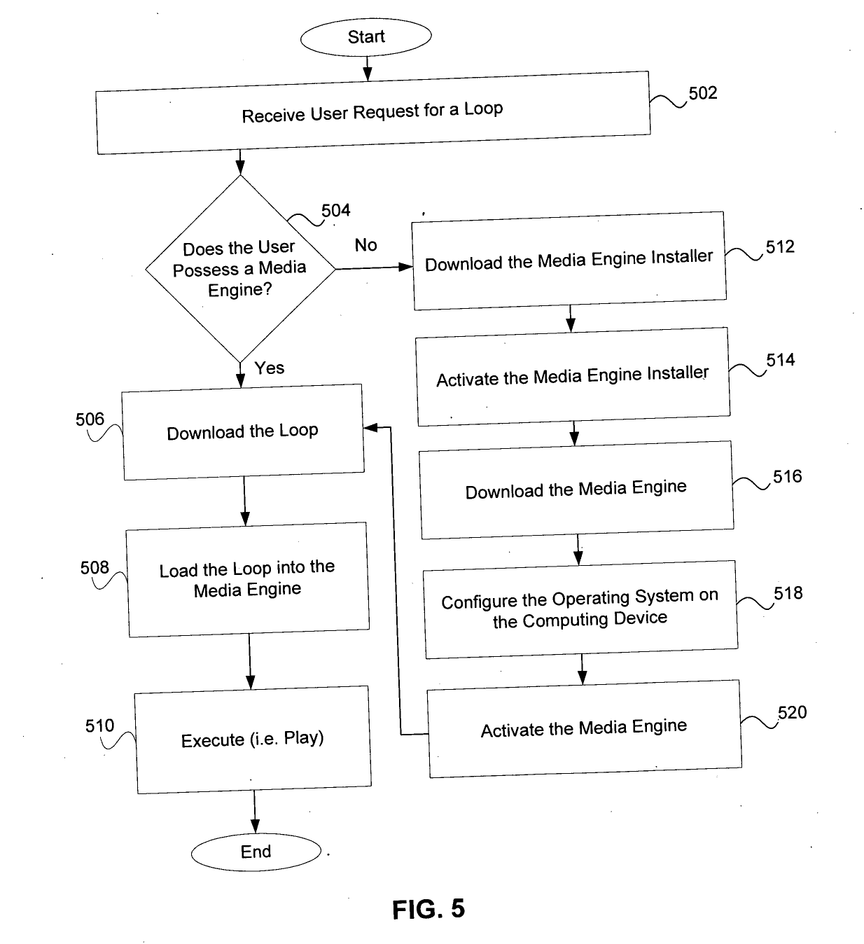

FIG. 5 shows a flowchart of an exemplary process for providing a loop. At step 502, a user request for a loop(s) 204 is received. The user request may be received from the client 102 or any other device. The user may submit the request for the loop(s) 204 by clicking on an icon at the server 106, by consenting to terms associated with the loop(s) 204, and so on.

At step 504, the server 106 determines whether the user possesses a media engine, such as the media engine 202 discussed herein. The server 106 may determine whether the client 102 has the media engine 202 by communicating with the client 102 or by any other method.

At step 506, if the server 106 determines that the user does possess the media engine 202, the loop(s) 204 is downloaded to the client 102. For example, the server 106 may download the loop(s) 204 with the media 204 pre-populated in the loop(s) 204, a partially populated loop(s) 204, or unpopulated loop(s) 204 may be downloaded. Any type of loop(s) 204 may be downloaded according to various embodiments.

At step 508, the loop(s) 204 is then loaded into the media engine 202. As discussed herein, one or more loops 206 may exist in one media engine 202. According to some embodiments, the server 106 may configure the media 202 comprising and/or the loop(s) 204 for the media engine 202.

At step 510, the loop(s) 204 is executed. Executing the loop(s) 204 may comprise playing or displaying the loop(s) 204 according to various embodiments. As discussed herein, the loop(s) 204 displays scrolling media 202 across a display device, such as the client 102, associated with the user. In response to the single request from the user, such as an input comprising a click of a button, the server 106 determines that the user possesses the media engine 202, downloads the loop(s) 204, loads the loop(s) 204 into the media engine 202, and executes the loop(s) 204 on the client 102.

If the server 106 determines, at step 504, that the user does not possess a media engine, the media engine 202 needs to be installed on the client 102. At step 512, accordingly, a media engine installer is downloaded to the client 102. Any type of media engine installer may be downloaded according to various embodiments. According to some embodiments, the media engine 202 and the loop(s) 204 are installed automatically in response to the user request for the loop(s) 204 using an installer resident on the client 102.

At step 514, the media engine installer is activated. The server 106 downloads the media engine installer and activates the media engine installer in exemplary embodiments. According to some embodiments, once activated, the media engine installer may assess any requirements associated with the client 102 as part of the activation process. For example, once activated, the media engine installer may scan the operating system of the client 102 to determine if any necessary components for the application are already installed within the operating system. The media engine installer defines a list of necessary components to download and install. The media engine installer may then contact the server 106 and request only those components that are not present within the client 102.

At step 516, the media engine 202 is downloaded. The client 102 receives the media engine 202 via the media engine installer. As discussed herein, in other embodiments, the server only downloads the components of the media engine 202 to the client 102.

At step 518, the operating system on the computing device is configured. The media engine installer configures the operating system according to configuration parameters established by the client 102, the server 106, the operating system, and/or the user. For example, the media engine installer may add or alter registry entries within the register of a Microsoft Windows operating system in order to configure the client 102 to execute the media engine 202. In another example, the media engine installer may modify the operating system to create icons and other displays to allow the user to interact with the media engine 202. Any type of configuration may be employed according to various embodiments.

At step 520, the media engine 202 is activated. Once the client 102 possesses the media engine 202, the loop(s) 204 can be downloaded in step 506 in response to the user's initial, single request. Since the media engine 202 was activated by the media engine installer, the media engine 202 may receive the loop(s) 204 and execute the loop(s) 204, according to steps 508, and 510, respectively.

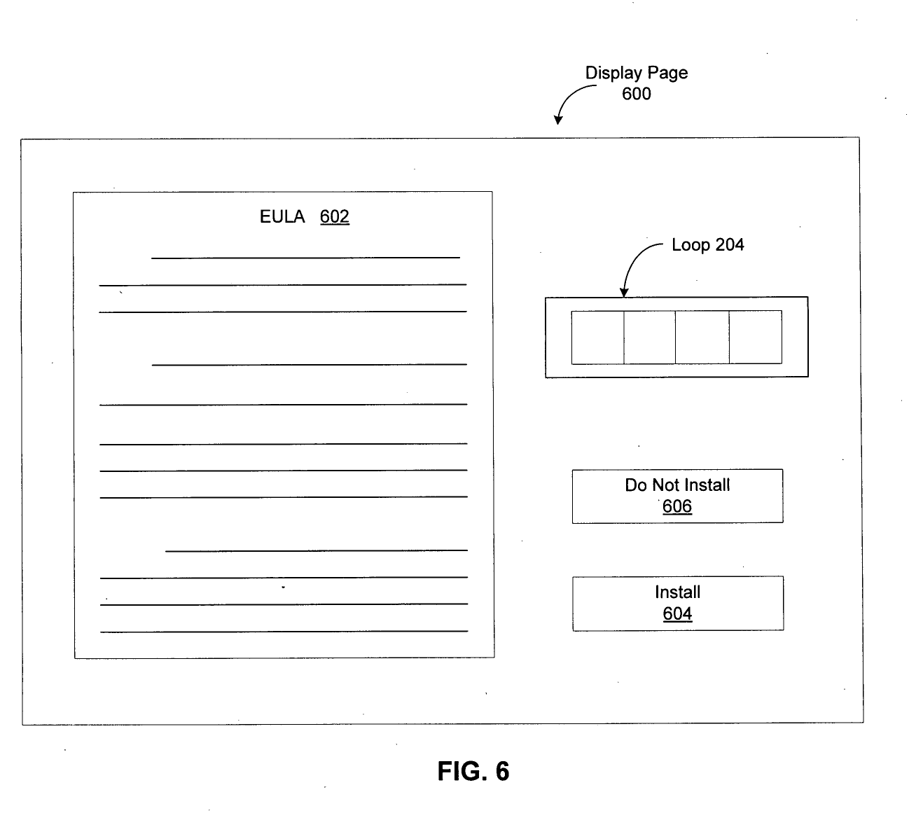

FIG. 6 shows an exemplary graphical user interface for installing a loop in response to a single user input. A display page 600 may display terms and conditions associated with the loop(s) 204, such as a EULA 602. A user associated with a computing device, such as the client 102, may read the EULA. Optionally, the user may click a box agreeing to the terms of the EULA.

Two options may be provided, as buttons or as other mechanisms for receiving user input. One button, for example, may comprise an “Install” button 604, as shown in FIG. 6. If the user clicks the “Install” button 604, the media engine 202 and/or the loop(s) 204 may be automatically installed on the client 102 in response to the single input from the user. In one embodiment, the loop(s) 204 is not installed at the client 102 if the user has not accepted the EULA 602, or any other agreement or terms and conditions.

A “Do Not Install” button 606 may also be provided, as shown in FIG. 6. If the user clicks the “Do Not Install” button 606, a message may appear explaining that the media engine 202 and/or the loop(s) 204 have not been installed. Any type of message may appear. In one embodiment, the user may be redirected to another display page, such as a home page of a website.

In some embodiments, options for installing the loop(s) 204 are displayed without displaying the EULA 602, other agreements, and/or other terms and conditions. In another embodiment, the user may be required to click twice to install the loop(s) 204. For example, the user may click an install button and receive the EULA 602. Once the user provides an indication that the user accepts the EULA 602, the user may request the loop(s) 204 by clicking another button to actually install the loop(s) 204

In some embodiments, a user may click an icon associated with the loop(s) 204 in order to have the media engine 202 installed and receive the loop(s) 204. For example, the user may visit a webpage where the user clicks on a loop icon and receives the loop(s) 204 and has the media engine 202 installed in response to clicking on the icon. In one embodiment, the user may be required to click another button or provide another indication to confirm that the user wants to download the loop(s) 204. An icon may be presented to the user with an explanation near the icon explaining that clicking the icon will automatically download the loop(s) 106 to the user's computer, such as the client 102.

In one embodiment, the user may search a directory that references loops 204, such as via a web page. The user may select one or more of the search results in order to automatically download the loop(s) 204 and install the media engine 202, if necessary, in response to clicking one or more of the search results or providing another indication that the user wants to download the loop(s) 204 and the media engine 202, if necessary.

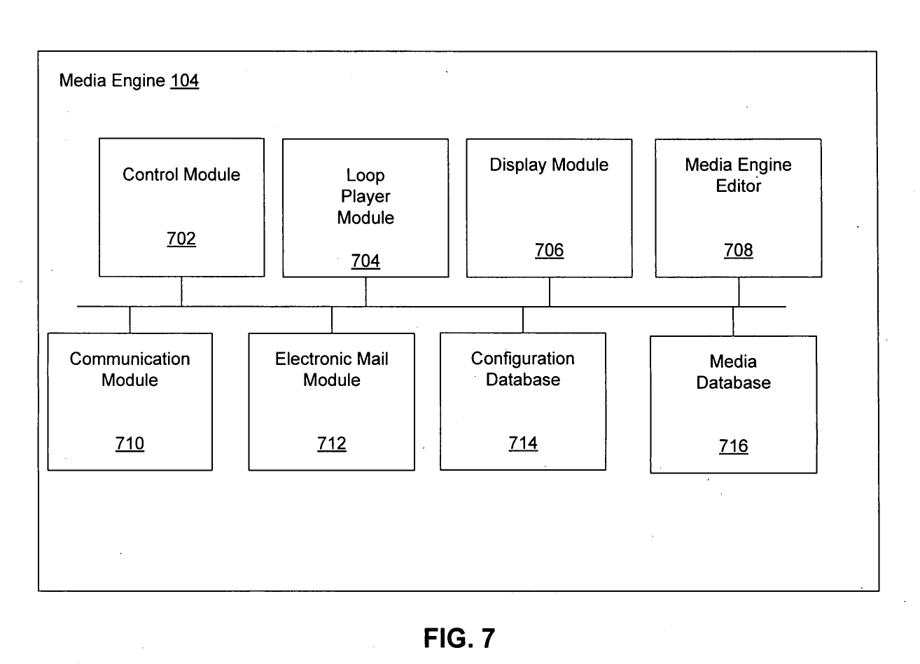

FIG. 7 shows a schematic diagram for an exemplary media engine 202. A loop control module 702 manipulates the media 206 (FIG. 2) and constructs the loop(s) 204 (FIG. 2) from the media 206. The loop control module 702 provides a default speed at which the loop(s) 204 plays. In a further embodiment, a user can specify the speed for playing the loop(s) 204 or adjust the speed from the default speed. The loop control module 702 may coordinate with the content provider 210 (FIG. 2) to insert specific content into the loop(s) 204 at specific times or in specific time intervals.

A loop player module 704, such as the loop player module 302 described in FIG. 3, plays the loop(s) 204. The loop player module 704 may be utilized to control a direction and a speed at which the loop(s) 204 plays. The loop player module 704 may have a default direction, which may be changed by the user.

A display module 706 provides a graphical user interface (GUI) for allowing the user to interact with logic of the media engine 202. For instance, the display module 706 allows the user to interact with the media engine 202 to read and write the media 206. In other words, the display module 706 allows the user to create, modify, and/or remove the media 206 and/or the loop(s) 204 by choosing from on-screen selections and/or manipulating on-screen items. The display module 706 may also execute the media 206 from within a window, display the media 206 alone or as part of the loop(s) 204, and/or perform any functions related to display and user interaction with the display.

As discussed herein, the display module 706 allows the user to drag and drop the media 206 into the loop(s) 204 and remove the media 206 from the loop(s) 204. The user can drag and drop the media 206, click a button, or initiate a voice command to send the media 206 changes to the media engine 202.

Any type of display module 706 is within the scope of various embodiments. For instance, the display module 706 need not present a typical visual display, but may be a text-based display module for allowing the user to interact with logic of the media engine 202 based on text command lines.

A media engine editor 708 allows the user to make adjustments to the media 206. For example, the user can use the media engine editor 708 to resize the media 206, rotate the media 206, configure the media 206, format the media 206, and so forth. For instance, the user may resize an image or change a font type of text associated with the media 206. Any type of editing may be accomplished using the media engine editor 708.

A communication module 710 allows the media engine 202 to utilize components of the client 102 for communicating with the server 106 to send and receive updates for the loop(s) 204 running in the media engine 202, and to transfer any other data between the media engine 202 and the server 106.

An electronic mail interface 712 may be provided as a communications interface for electronic mails. Any type of electronic mail interface 712 may be provided. The electronic mail interface 712 may be utilized for sending the loop(s) 204, the media 206, metadata, or identifiers associated with the loop(s) 204 and/or the media 206 directly to other users.

A configuration database 714 may be utilized to store the one or more identifiers associated with the media 206 and/or the loop(s) 204. As discussed herein, when the loop(s) 204 is created using the media 206 or updates to the loop(s) 204 are provided, an identifier is assigned to the loop(s) 204 or the media 206. In further embodiments, the media 206 in the loop(s) 204 is assigned an identifier that is unique within the loop(s) 204.

The configuration database 714 may store any type of data related to the loop(s) 204, such as information regarding a host computer system, type and quality of an attached network, communications performance, registration information for the client 102, version number for the loop(s) 204 and the media 206 comprising the loop(s) 204. Any type of configuration database 714 may be utilized in accordance with various embodiments. As discussed herein, in one embodiment, the identifier is stored on the server 106 and/or in the configuration database 714. In alternative embodiments, the configuration database 714 may comprise more than a database. In yet a further embodiment, the configuration database 714 may be located outside the media engine 202, but be coupled thereto. It should be noted that the configuration database 714 and the media database 716 may comprise a single database.

A media database 716 may be provided for storing the media 206. In one embodiment, the content from the content provider 210 is stored in the media database 716. Any process for storing the media 206 may be utilized in association with the media database 716. For example, a hash function may be utilized to index and retrieve the media 206 in the media database 712 or from one or more other storage mediums.

Although the media engine 202 is described as including various components, the media engine 202 may include more components or fewer components than those listed and still fall within the scope of embodiments of the invention. For example, the media engine 202 may also include a media cache/buffer for short term storage of the media 206, an input/output (I/O) component for receiving and sending data at the client 102, a contact database for storing information associated with contacts, a user activity component for tracking activity of the user with respect to the media 206 and/or the loop(s) 204, and so forth.

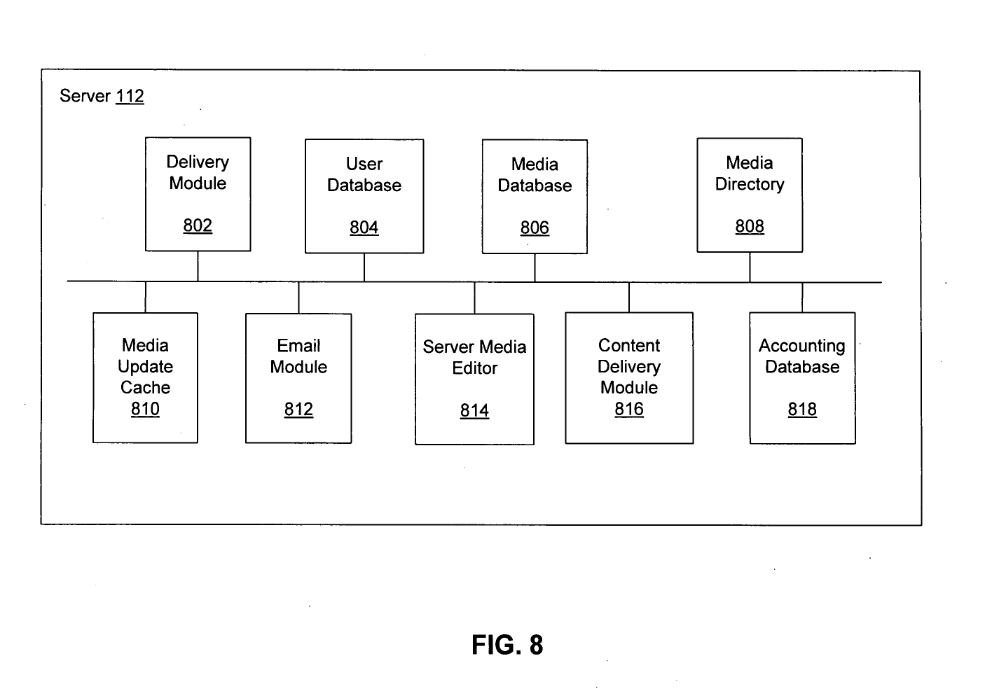

FIG. 8 shows exemplary components associated with the server 106. A delivery module 802 may be provided for delivering the loop(s) 204 (FIG. 2), and the media 206 (FIG. 2) that comprise the loop(s) 204, as well as the identifiers assigned to the loop(s) 204 and the media 206 to clients.

In one embodiment, the media 206 is provided to the media engine 202 for creating the loop(s) 204. The media engine 202 then requests the server 106 create the loop(s) 204 with the media 206. Alternatively, as discussed herein, the media engine 202, itself, may create the loop(s) 204. The server 106 and/or the media engine 202 can assign an identifier to the loop(s) 204 and to each of the one or more items of media 206 comprising the loop(s) 204. If the server 106 creates the loop(s) 204 or maintains a master copy of the loop(s) 204, the server 106 can deliver the loop(s) 204 to the media engine 202 via the network 104, as discussed herein. However, any manner of delivering the loop(s) 204 to the media engine 202 is within the scope of various embodiments.

A user database 804 may be provided for storing user information, such as first and last names, electronic mail addresses, user identifiers, and so on. The user database 804 may also store information associated with the loop(s) 204 that the user created or received from other users. Based on the identifiers from the loop(s) 204, the user database 804 can provide the media 206 as updates to the appropriate loop(s) 204 in the media engines 202, such as the loop player 302, running on the client 102 or the client(s) 208. Optionally, a user may be required to register certain information with the server 106 before the server 106 will provide the loop(s) 204 with the media 206 to the loop player(s) 302 (FIG. 3) associated with the user. Alternatively, the user may be required to register in order to receive the identifier for the media 206 and/or the loop(s) 204.

A media database 806 may also be provided for storing the media 206 the loop(s) 204 and/or any metadata or configuration information associated with the loop(s) 204 and/or the media 206. As discussed herein, the media 206 and/or the loop(s) 204 may include, for example, multimedia, photographs, sounds, music, pictures, streaming media, animation, movies, and graphics. Any type of media 206 may comprise the loop(s) 204.

A media directory 808 may be provided for indexing the media 206 stored in the media database 806. For example, in one embodiment, the media directory 808 may allow the loop(s) 204 and/or media 206 to be retrieved that have the word “fishing” in their titles or descriptions. Any indexing and searching by the media directory 808 on any information or metadata associated with the loop(s) 204 or the media 206 is within the scope of various embodiments.

A media update cache 810 stores the media 206 that is utilized to update, or otherwise modify, the loop(s) 204.

An electronic mail module 812 sends electronic mail for the user at the client 102 to the one or more other users at the client(s) 208, providing the users at the client(s) 208 with information for retrieving or constructing the loop(s) 204 and/or the media engine 202.

A server media editor 814 may be provided for modifying the media 206. The user can modify the media 206 utilizing the server media editor 814 via the server 106 rather than, or in addition to, the media engine editor 708 (FIG. 7). For example, the server media editor 814 may be used to resize photos, rotate photos, remove red eye from photos, correct color balance, cleanse the media 206 of viruses, and so forth.

As discussed in FIG. 2, a content provider 210 may be coupled to the server 106. Alternatively, the function of the content provider 210 may be performed by a content delivery module 816 within the server 106. The content delivery module 816 provides advertising and/or any other type of content to be included as one or more items of the media 206 within the loop(s) 204.

In one embodiment, the advertising and/or content from the content delivery module 816 may be provided based on an analysis of the user of the loop(s) 204. For example, an advertisement for toothpaste may be provided to a user with family related loops 206. However, any manner of determining the advertising and/or the content to be provided by the content delivery module 816 to the loop(s) 204 may be employed, such as arbitrarily choosing the advertising and/or the content.

In one embodiment, the media 206 may comprise more than one advertising media inserted into the loop(s) 204. As discussed herein, the content provider 210 and/or the content delivery module 816 may dictate how frequently the advertising media, or other content, appears. For instance, the advertising media may appear twice in the loop(s) 204, once for every five items of the media 206 in the loop(s) 204, and so on.

A commercial loop(s) 204 may also be created utilizing the content delivery module 816. The commercial loop(s) 204 may include media with embedded music, streaming video, audio, and/or other multimedia effects. A user may choose to allow the commercial loop(s) 204 to play on a display device associated with the user's client 102.

The server 106 may also include an accounting database 818. The accounting database 818 can track the media 206 within the loop(s) 204, and track the frequency and type of interaction each of the users has with the loop(s) 204 on the media 206. Specifically, the accounting database 818 is useful for tracking the interaction between the user and the advertisement media included within the loop(s) 204. Accordingly, the accounting database 818 can track monies due to a provider of the advertising media based on user interaction with the advertising media.

Although the server 106 has been described as including various components, fewer or more components may comprise the server 106 in accordance with various embodiments. For instance, the server 106 may also include a search engine component, or a communications interface.

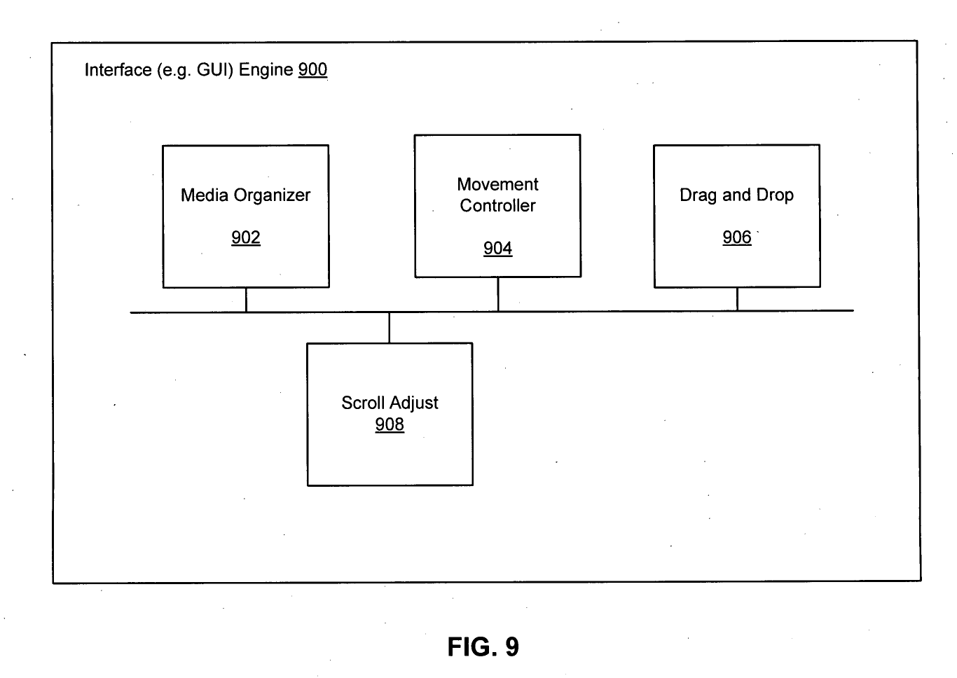

Turning now to FIG. 9, an exemplary graphical user interface for providing access to functions related to the media engine 202 (FIG. 2) is shown. In one embodiment, the GUI engine 900 is the display module 704 (FIG. 8). A media organizer 902 allows a user to organize the media 206 (FIG. 2) in the loop(s) 204 (FIG. 2). For example, the user can provide photos to the media organizer 902 via a drag and drop function, a keystroke, etc., and the media organizer 902 can automatically organize the photos according to default parameters or parameters specified by the user. The default parameter may be, for instance, to organize the photos according to dates associated with the photos. The user can specify any parameters, such as date, size, event, and so forth, for the media organizer 902 to use in arranging the media 206.

A movement controller 904 provides the user with a mechanism to regulate the pace of the loop(s) 204, as discussed herein, as it scrolls across a display device associated with the client 102. For example, the user may specify that the loop(s) 204 should scroll across the display device at a rate of one display device pixel per tenth of a second. The movement controller 904 also allows the user to specify the direction the loop(s) 204 should scroll across the display device of the client 102. For example, the user may specify that the loop(s) 204 should scroll left to right across the display device. Any manner of allowing the user to adjust the pace may be provided. For instance, the user may enter the scroll time into a box, move a slider between a slowest pace and fastest pace, select from scroll paces from a drop down menu, and so on.

A drag/drop manager 906 provides a mechanism for the user to modify the loop(s) 204 in a single drag and drop action. Thus, the user can drag one or more items of the media 206 into the loop(s) 204. The drag/drop manager 906 communicates the user action and information to other components/modules associated with the media engine 202 for automatically updating the loop(s) 204 to include the dropped media 206. As discussed herein, when the user performs this single act of dragging and dropping the media 206 into the loop(s) 204, one or more other loop(s) 204 that share the identifier are also updated with the dropped media 206. As discussed herein, the other loop(s) 204 may reside in other loop players 302 (FIG. 3) at the client(s) 208. Conversely, the user can drag one or more items of the media 206 away from the loop(s) 204, in order to remove the items. The loop(s) 204 that share the same identifier are also updated to no longer include the media 206 dragged away from the loop(s).

A scroll adjust 908 option may also be provided via the GUI engine 900. The scroll adjust 908 allows the user to manipulate the loop(s) 204 as they scroll across a display device. For instance, as the loop(s) 204 scrolls across the display device, the user can grab the loop(s) 204 with a mouse, keystroke, etc., and move the loop(s) 204. The user can stop the scrolling, slow down the scrolling, speed up the scrolling, and so forth by clicking on, moving, etc. the loop(s) 204, itself. The user can choose which of the loop(s) 204 and/or how many of the loop(s) 204 the user wants to scroll on the user's display device at one time.

Although an exemplary graphical user GUI engine 900 has been described, any type of graphical user interface engine with any type of functionality is within the scope of various embodiments. For example, the GUI engine 900 may include mechanisms for allowing functionality such as creating another loop when the user selects the one or more items of the media 206 comprising the loop(s) 204, displaying a larger image when the user selects the one or more items of the media 206 in the loop(s) 204, dragging and dropping the entire loop(s) 204 from one media engine 202 to another media engine 202, creating a new empty loop 204 from when the user selects an item of the media 206 in the loop(s) 204, sending an electronic mail message to other users that contains a copy of the entire loop(s) 204 or information related to specific loops 208, providing the ability to search for various loops 208 associated with the client 102, client(s) 208, and/or stored in a publicly accessible media directory 808, and so forth.

The above-described functions can be comprised of instructions that are stored on a storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with the invention. Those skilled in the art are familiar with instructions, processor(s), and storage medium.

While various embodiments have been described above, it should be understood that they have been presented by way of example only, and not limitation. For example, any of the elements associated with the applications or film loop(s) may employ any of the desired functionality set forth hereinabove. Thus, the breadth and scope of a preferred embodiment should not be limited by any of the above-described exemplary embodiments.

What is claimed is:

1. A method for installing an application in response to a single input, comprising:
receiving a single input for an application from a user;
in response to the single input, downloading the application;
storing data associated with the application on a computing device associated with the user;
configuring the data on the computing device; and
executing the application on the computing device.

2. The method recited in claim 1, wherein the application comprises a media engine for executing one or more loops.

3. The method recited in claim 1, wherein the application comprises a media engine for displaying one or more loops.

4. The method recited in claim 3, wherein the one or more loops are comprised of at least one item of media displayed within the one or more loops.

5. The method recited in claim 3, further comprising downloading the one or more loops to the computing device.

6. The method recited in claim 5, further comprising loading the one or more loops into the media engine.

7. The method recited in claim 1, further comprising providing an installation program in response to the single input for downloading the application, storing the data, configuring the data, and executing the application in response to the request from the user.

8. The method recited in claim 1, wherein the single input received from the user comprises selection of an icon associated with the application.

9. The method recited in claim 1, wherein the single input received from the user comprises an indication that the user accepts the terms of an agreement associated with the application.

10. The method recited in claim 1, wherein the single input received from the user comprises a serial number associated with the application input by the user.

11. A system for installing an application in response to a single input, comprising:
a server configured to receive a single input for an application from a user and in response to the single input, sends the application, stores data associated with the application on a computing device associated with the user, configures the data on the computing device, and executes the application on the computing device.

12. The system recited in claim 11, wherein the server is further configured to send an installer program with the application.

13. The system recited in claim 12, wherein the installer program is configured to store data associated with the application on a computing device associated with the user, configures the data on the computing device, and executes the application on the computing device.

14. The system recited in claim 11, wherein an installer program is executed on the computing device prior to the single input.

15. The system recited in claim 11, wherein the application comprises a media engine for executing one or more loops.

16. The system recited in claim 11, wherein the application comprises a media engine for displaying one or more loops.

17. The system recited in claim 16, wherein the one or more loops are comprised of at least one item of media displayed within the one or more loops.

18. The system recited in claim 16, wherein the server is further configured to download the one or more loops to the computing device.

19. The system recited in claim 18, wherein the media engine is configured to load the one or more loops.

20. The system recited in claim 11, wherein the server provides an installation program in response to the single input for downloading the application, storing the data, configuring the data, and executing the application in response to the single input from the user.

21. The system recited in claim 11, wherein the single input received from the user comprises selection of an icon associated with the application.

22. The system recited in claim 11, wherein the single input received from the user comprises an indication that the user accepts the terms of an agreement associated with the application.

23. The system recited in claim 11, wherein the single input received from the user comprises a serial number associated with the application input by the user.

24. A program embodied on a computer readable medium, the program being executable by a computing device to perform a method for installing an application in response to a single input, the method comprising:
receiving a single input for an application from a user;
in response to the single input, downloading the application;
storing data associated with the application on a computing device associated with the user;
configuring the data on the computing device; and
executing the application on the computing device.

25. The program recited in claim 24, wherein the application comprises a media engine for executing one or more loops.

26. The program recited in claim 24, wherein the application comprises a media engine for displaying one or more loops.

27. The program recited in claim 26, wherein the one or more loops are comprised of at least one item of media displayed within the one or more loops.

28. The program recited in claim 26, further comprising downloading the one or more loops to the computing device.

29. The program recited in claim 28, further comprising loading the one or more loops into the media engine.

30. The program recited in claim 24, wherein the method further comprises providing an installation program in response to the single input for downloading the application, storing the data, configuring the data, and executing the application in response to single input from the user.

31. The program recited in claim 24, wherein the single input received from the user comprises selection of an icon associated with the application.

32. The program recited in claim 24, wherein the single input received from the user comprises an indication that the user accepts the terms of an agreement associated with the application.

33. The program recited in claim 24, wherein the single input received from the user comprises a serial number associated with the application input by the user.

34. A system for installing an application in response to a single input, comprising:
a server configured to receive a single input for an application from a user and in response to the single input, sends the application and an application installer to a computing device associated with the user, the application installer configured to store data associated with the application on the computing device, to configure the data on the computing device, and to execute the application on the computing device.

35. A method for installing an application in response to a single request from a user, comprising:
in response to a single input comprising a request for an application from a user, downloading the application; and
executing the application on a computing device associated with the user in response to the request.

36. The method recited in claim 35, the method further comprises storing and configuring data associated with the application on the computing device.
